(19) United States
(12) Patent Application Publication
(10) Pub. No.: US 2026/0265031 A1
(43) Pub. Date: Sep. 10, 2026

(54) MOVING BODY CONTROL METHOD, MOVING BODY, AND PROGRAM

(71) Applicant: MITSUBISHI HEAVY INDUSTRIES, LTD., Tokyo (JP)

(72) Inventors: Yohei Chishiki, Tokyo (JP); Kenji Takao, Tokyo (JP)

(73) Assignee: MITSUBISHI HEAVY INDUSTRIES, LTD., Tokyo (JP)

(21) Appl. No.: 19/161,089

(22) PCT Filed: Feb. 6, 2024
(86) PCT No.: PCT/JP2024/003886

§ 371 Date: Aug. 29, 2025

(30) Foreign Application Priority Data
Apr. 18, 2023 (JP) 2023-068048

(51) Int. Cl. B66F 9/075; B66F 9/06; B66F 9/24

(52) U.S. Cl. CPC B66F 9/0755; B66F 9/063; B66F 9/24

(57) ABSTRACT

A control method of a moving body that includes a pair of claws for holding a target object which is a transport target, includes: a step of inserting the claws into an opening formed in the target object; a step of detecting inclination angles of the claws inserted into the opening with respect to the target object; and a step of detecting deviation amounts of the claws inserted into the opening. In the step of detecting the inclination angles, the inclination angles are calculated based on a time difference between times when respective base end portions of the claws and the target object come into contact with each other and on a speed at which the claws are inserted into the opening.

### TECHNICAL FIELD

The present disclosure relates to a control method of a moving body, a moving body, and a program.

### BACKGROUND ART

For example, a technique in which a moving body such as a forklift is moved to automatically transport a target object placed on a pallet is known. In this type of transport technique, it is necessary to accurately transport the target object to a predetermined position. For this reason, when claws of the forklift (moving body) are inserted into an opening of the pallet (the target object), it is required to accurately detect a deviation amount of the claws with respect to the pallet. For example, PTL 1 describes a technique of determining a deviation amount of a claw when the claw is inserted into a pallet, from a position coordinate of the pallet detected by using an image captured by a camera mounted on a forklift and a position coordinate of the claw of the forklift.

### CITATION LIST

### Patent Literature

[PTL 1] Japanese Unexamined Patent Application Publication No. 2021-160894

### SUMMARY OF INVENTION

### Technical Problem

However, in the technique of the related art, since the deviation amount in a case where the claw is inserted is estimated from each position coordinate before the claw is inserted into the pallet, there is a concern that a deviation of the target object with respect to the moving body remains and that the target object cannot be appropriately transported.

The present disclosure is devised to solve the problem described above, and an object thereof is to provide a control method of a moving body, a moving body, and a program, with which a target object can be appropriately transported.

### Solution to Problem

According to an aspect of the present disclosure, in order to solve the problem described above and to achieve the object, there is provided a control method of a moving body that includes a pair of claws for holding a target object which is a transport target, the control method including a step of inserting the claws into an opening formed in the target object, a step of detecting inclination angles of the claws inserted into the opening with respect to the target object, and a step of detecting deviation amounts of the claws inserted into the opening.

According to another aspect of the present disclosure, in order to solve the problem described above and to achieve the object, there is provided a moving body that includes a pair of claws for holding a target object which is a transport target, the moving body including a fork control unit that inserts the claws into an opening formed in the target object, an inclination angle detecting unit that detects inclination angles of the claws inserted into the opening with respect to the target object, and a deviation amount detecting unit that detects deviation amounts of the claws inserted into the opening.

According to still another aspect of the present disclosure, in order to solve the problem described above and to achieve the object, there is provided a program causing a computer to execute a control method of a moving body that includes a pair of claws for holding a target object which is a transport target, the program causing the computer to execute a step of inserting the claws into an opening formed in the target object, a step of detecting inclination angles of the claws inserted into the opening with respect to the target object, and a step of detecting deviation amounts of the claws inserted into the opening.

### Advantageous Effects of Invention

According to the present disclosure, the target object can be appropriately transported.

### BRIEF DESCRIPTION OF DRAWINGS

FIG. 1 is a schematic view of a movement control system according to a first embodiment.

FIG. 2 is a schematic view of a configuration of a moving body.

FIG. 3 is a schematic block diagram of an information processing device.

FIG. 4 is a schematic block diagram of a control device of the moving body.

FIG. 5 is a schematic view showing an example of an operation of the moving body when picking up a target object.

FIG. 6 is a flowchart showing a control procedure of detecting an inclination angle and a deviation amount of a claw.

FIG. 7 is a schematic view showing a positional relationship between the target object and the claw in the control procedure.

FIG. 8 is a schematic view showing a positional relationship between the target object and the claw in the control procedure.

FIG. 9 is a schematic view showing processing of acquiring position information of the target object.

FIG. 10 is a schematic view showing processing of moving the moving body holding the target object to a transport region.

FIG. 11 is a schematic view for describing an operation of detecting a deviation amount of a claw in a moving body according to a second embodiment.

FIG. 12 is a schematic view for describing an operation of detecting a deviation amount of a claw in a moving body according to a third embodiment.

FIG. 13 is a schematic view for describing the operation of detecting the deviation amount of the claw in the moving body according to the third embodiment.

### DESCRIPTION OF EMBODIMENTS

Hereinafter, preferred embodiments of the present disclosure will be described in detail with reference to the accompanying drawings. The present disclosure is not limited by the embodiments, and in a case where there are a plurality of embodiments, the present disclosure also includes configurations where the respective embodiments are combined with each other.

### First Embodiment

### (Movement Control System)

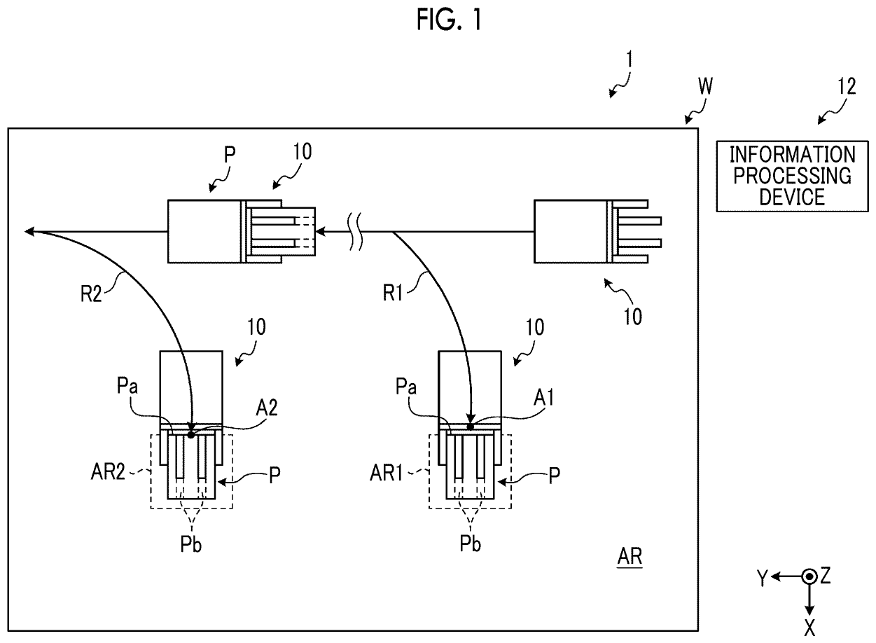

FIG. 1 is a schematic view of a movement control system according to a first embodiment. As shown in FIG. 1, a movement control system 1 according to the first embodiment includes a moving body 10 and an information processing device 12. The movement control system 1 is a system that controls a movement of the moving body 10 belonging to a facility W. The facility W is, for example, a facility that is involved in physical distribution management, such as a warehouse. In the movement control system 1, the moving body 10 moves along a first route R1 to a placement region AR1 in a region AR of the facility W and loads (picks up) a target object P disposed in the placement region AR1. Then, the moving body 10 moves to a transport region AR2 along a second route R2 in a state where the target object P is loaded and unloads (drops) the target object P in the transport region AR2. The region AR is, for example, a floor surface of the facility W and is a region where the target object P is placed or the moving body 10 moves. The target object P is an object to be transported on which cargo is loaded on a pallet in the present embodiment. A hole (opening) Pb into which a fork 24 of the moving body 10, which is to be described later, is inserted is formed in a front surface Pa (for example, a front surface of the pallet) of the target object P.

Hereinafter, a direction along the region AR will be referred to as an X-direction, and a direction along the region AR and intersecting the X-direction will be referred to as a Y-direction. In the present embodiment, the Y-direction is a direction orthogonal to the X-direction. The X-direction and the Y-direction may be directions along a horizontal plane. In addition, a direction orthogonal to each of the X-direction and the Y-direction, more specifically, a direction toward an upper side in a vertical direction, will be referred to as a Z-direction. In addition, in the present embodiment, the term “position” refers to a position (coordinates) in a coordinate system (a coordinate system of the region AR) on a two-dimensional plane in the region AR, unless particularly stated otherwise. In addition, a “posture” of the moving body 10 or the like is, unless particularly stated otherwise, a direction of the moving body 10 or the like in the coordinate system of the region AR and refers to a yaw angle (rotation angle) of the moving body 10 when the X-direction is set to 0° in a case of being viewed from the Z-direction.

### (Placement Region and Transport Region)

In the region AR in the facility W, a plurality of placement regions AR1 are provided. The placement region AR1 is a region where the target object P is placed, that is, a region of a transport source. The placement region AR1 is set in advance as a region where the target object P is placed. The placement region AR1 is divided by, for example, white lines or the like, and a position (coordinates), a shape, and a size of the placement region AR1 are set in advance. Similarly, a plurality of transport regions AR2 are provided in the region AR in the facility W. The transport region AR2 is a region where the target object P is to be placed, that is, a transport destination region. The transport region AR2 is set in advance as a region where the target object P is to be placed. The transport region AR2 is divided by, for example, white lines or the like, and a position (coordinates), a shape, and a size of the transport region AR2 are set in advance. In the present embodiment, the placement region AR1 and the transport region AR2 are provided in the region AR which is a floor of the facility W. However, without being limited thereto, for example, the target object P may be provided in a load platform of a vehicle that has transported the target object P into the facility W or may be provided on a shelf or the like of the facility W. In addition, in the present embodiment, the placement region AR1 and the transport region AR2 are partitioned for each target object P, and one target object P is disposed in each of the placement region AR1 and the transport region AR2. However, the present disclosure is not limited thereto. For example, at least one of the placement region AR1 and the transport region AR2 may be set as a free space such that a plurality of target objects P are placed. In addition, in the example of FIG. 1, the placement region AR1 and the transport region AR2 are rectangular, but the shape and the size may be any shape and any size. In addition, the number of placement regions AR1 or transport regions AR2 provided in the region AR may be any number.

### (Moving Body)

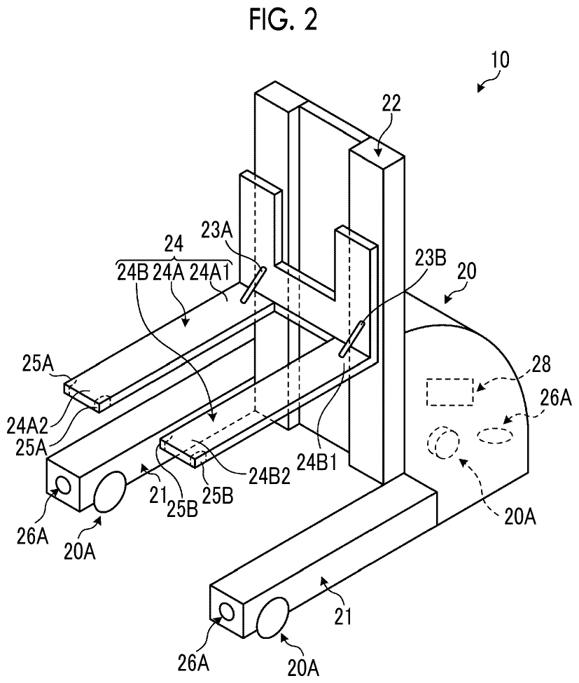

FIG. 2 is a schematic view of a configuration of the moving body. The moving body 10 is a device that can automatically move and that can transport the target object P. Further, in the present embodiment, the moving body 10 is an unmanned forklift and, more specifically, is a so-called automated guided vehicle (AGV) or a so-called automated guided forklift (AGF). As shown in FIG. 2, the moving body 10 includes a car body 20, wheels 20A, straddle legs 21, a mast 22, the fork 24, a sensor 26A, and a control device 28. The straddle legs 21 are a pair of shaft-shaped members that are provided at one end portion of the car body 20 in a front-rear direction and that protrude from the car body 20. The wheels 20A are provided at tips of the straddle legs 21 and on the car body 20, respectively. That is, although a total of three wheels 20A are provided, positions and the number of the wheels 20A may be any positions and any number. The mast 22 is movably attached to the straddle legs 21 and moves in the front-rear direction of the car body 20. The mast 22 extends along an up-down direction (herein, the Z-direction) orthogonal to the front-rear direction. The fork 24 is attached to the mast 22 to be capable of ascending and descending (movable in the Z-direction). The fork 24 may also be movable with respect to the mast 22 in a horizontal direction (a direction intersecting the up-down direction and the front-rear direction) of the car body 20.

The fork 24 has a pair of claws 24A and 24B. The claws 24A and 24B extend from the mast 22 toward a front direction of the car body 20. The claws 24A and 24B are disposed to be separated from each other at a predetermined interval in the horizontal direction (right-left direction) of the mast 22. Hereinafter, in the front-rear direction, a direction of the moving body 10 on a side where the fork 24 (the claws 24A and 24B) is provided will be referred to as a front direction, and a direction on a side where the fork 24 is not provided will be referred to as a rear direction. In addition, a mast 22 side of the claws 24A and 24B in an extending direction will be referred to as a base end side, and a side opposite to the mast 22 will be referred to as a tip side. The pair of claws 24A and 24B includes base end side sensors 23A and 23B and tip side sensors 25A and 25B, respectively. The base end side sensors 23A and 23B are provided on upper surfaces of base end portions 24A1 and 24B1 of the claws 24A and 24B, respectively. For example, a limit switch or the like can be used as the base end side sensors 23A and 23B. The base end side sensors 23A and 23B are operated by coming into contact with the front surface Pa of the target object P around the hole Pb when the fork 24 (the claws 24A and 24B) is inserted into the hole Pb of the target object P (see FIG. 1) and detect the contact. In addition, the tip side sensors 25A and 25B are provided on both side surfaces (corner portions) of tip portions 24A2 and 24B2 of the claws 24A and 24B, respectively. For example, a pressure sensor or the like can be used as the tip side sensors 25A and 25B. The tip side sensors 25A and 25B are operated by coming into contact with an inner wall surface of the hole Pb when the fork 24 (claws 24A and 24B) is inserted into the hole Pb of the target object P and detect the contact.

The sensor 26A detects at least one of a position and a posture of the target object present around the car body 20. It can be said that the sensor 26A detects at least one of the position of the target object with respect to the moving body 10 and the posture of the target object with respect to the moving body 10. In the present embodiment, the sensor 26A is provided at the tip of each straddle leg 21 in the front direction and on a rear direction side of the car body 20. However, a position where the sensor 26A is provided is not limited thereto, the sensor 26A may be provided at any position, and the number of sensors 26A provided may also be any number. For example, a safety sensor provided on the moving body 10 may be the sensor 26A.

The sensor 26A is, for example, a sensor that emits laser light. The sensor 26A emits laser light while performing scanning in one direction (herein, the horizontal direction) and detects the position and the direction of the target object from reflected light of the emitted laser light. That is, the sensor 26A can also be said to be a so-called two-dimensional (2D)-light detection and ranging (LiDAR). However, the sensor 26A is not limited to the above sensor and may be a sensor that detects the target object through any method and may be, for example, a so-called three-dimensional (3D)-LiDAR that is caused to perform scanning in a plurality of directions or a so-called one-dimensional (1D)-LiDAR that is not caused to perform scanning.

The control device 28 controls the movement of the moving body 10. The control device 28 will be described later.

### (Information Processing Device)

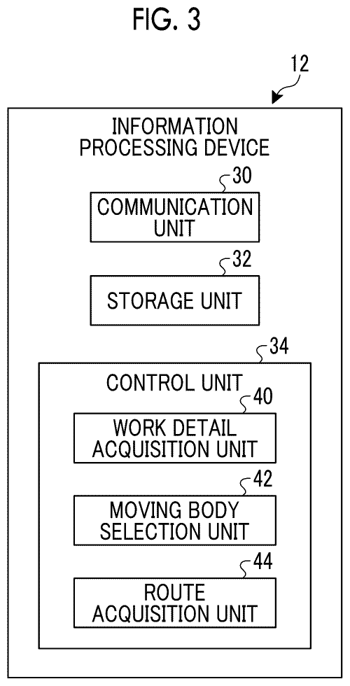

FIG. 3 is a schematic block diagram of the information processing device. The information processing device 12 is a device that is provided in the facility W and that calculates at least information related to the movement of the moving body 10, that is, a so-called ground system. However, the placement position of the information processing device 12 or the like is any position and is not limited to a so-called ground system. The information processing device 12 is a computer and as shown in FIG. 3, includes a communication unit 30, a storage unit 32, and a control unit 34. The communication unit 30 is a module that is used in the control unit 34 and that communicates with an external device such as the moving body 10 and may include, for example, an antenna or the like. A communication method of the communication unit 30 is wireless communication in the present embodiment, but the communication method may be any method. The storage unit 32 is a memory that stores various types of information, such as calculation content of the control unit 34 and programs, and includes, for example, at least one of a main storage device, such as a random-access memory (RAM) and a read-only memory (ROM), and an external storage device, such as a hard disk drive (HDD).

The control unit 34 is a calculation device and includes, for example, a calculation circuit such as a central processing unit (CPU). The control unit 34 includes a work detail acquisition unit 40, a moving body selection unit 42, and a route acquisition unit 44. The control unit 34 reads a program (software) from the storage unit 32 and executes the program to realize the work detail acquisition unit 40, the moving body selection unit 42, and the route acquisition unit 44 and executes processing thereof. The control unit 34 may execute the processing with one CPU or may include a plurality of CPUs and execute the processing with the plurality of CPUs. In addition, at least part of the work detail acquisition unit 40, the moving body selection unit 42, and the route acquisition unit 44 may be realized by a hardware circuit. In addition, a program for the control unit 34 stored in the storage unit 32 may be stored in a recording medium that can be read by the information processing device 12.

### (Work Detail Acquisition Unit and Moving Body Selection Unit)

The work detail acquisition unit 40 acquires information on work details, that is, information on the target object P, that is, a transport target. The work detail acquisition unit 40 may acquire the work details through any method, but may acquire the work details set by a management system (not shown), for example. The management system herein may be, for example, a back-end system such as a warehouse management system (WMS) and other production management system. The work detail acquisition unit 40 identifies the placement region AR1 where the target object P is placed and the transport region AR2 that is the transport destination from information of the target object P in the work details. For example, in the storage unit 32, the target object P, the placement region AR1 where the target object P is placed, and the transport region AR2 that is the transport destination are stored in association with each other. The work detail acquisition unit 40 identifies the placement region AR1 and the transport region AR2 by reading the information from the storage unit 32. The moving body selection unit 42 selects the moving body 10, which is a target. The moving body selection unit 42 selects the moving body 10, which is the target, for example, from a plurality of moving bodies that belong to the facility W. Although the moving body selection unit 42 may select the moving body 10 that is the target through any method, the moving body 10 suitable for transporting the target object P in the placement region AR1 may be selected as the moving body 10 that is the target, for example, based on the placement region AR1 identified by the work detail acquisition unit 40.

### (Route Acquisition Unit)

The route acquisition unit 44 acquires information on the route of the moving body 10. In the present embodiment, the route acquisition unit 44 acquires information on the first route R1 toward the placement region AR1 and information on the second route R2 toward the transport region AR2. The route acquisition unit 44 transmits the acquired information on the first route R1 and the second route R2 to the moving body 10 that is the target via the communication unit 30.

As shown in FIG. 1, the first route R1 is a trajectory to a position (target position A1) where the moving body 10 is at a predetermined position and posture with respect to the placement region AR1. The target position A1 can be said to be a position and posture at which the moving body 10 can pick up the target object P in a case where it is assumed that the target object P is at a reference position and reference posture set in advance in the placement region AR1. The first route R1 is set in advance, for example, for each placement region AR1. The route acquisition unit 44 acquires, for example, the first route R1 set for the placement region AR1 identified by the work detail acquisition unit 40, from the storage unit 32. The first route R1 is set with the coordinate system (the coordinate system of the region AR) in the two-dimensional plane in the region AR as reference, and thus is a trajectory in the coordinate system of the region AR. However, without being limited thereto, the first route R1 may be a trajectory in a global coordinate system.

As shown in FIG. 1, the second route R2 is a trajectory to a position (target position A2) where the moving body 10 is at a predetermined position and posture with respect to the transport region AR2. In the present embodiment, the second route R2 is preferably a trajectory from the target position A1 to the target position A2. The target position A2 can be said to be a position and posture at which the held target object P (that is, the target object P held at a predetermined position and posture with respect to the moving body 10) can be dropped within the transport region AR2 without being deviated with respect to the moving body 10. The second route R2 is set in advance, for example, for each transport region AR2. The route acquisition unit 44 acquires, for example, the second route R2 set for the transport region AR2 identified by the work detail acquisition unit 40, from the storage unit 32. The second route R2 is set with the coordinate system (the coordinate system of the region AR) in the two-dimensional plane in the region AR as reference, and thus is a trajectory in the coordinate system of the region AR. However, without being limited thereto, the second route R2 may be a trajectory in the global coordinate system.

The first route R1 and the second route R2 are set in advance based on map information of the facility W. The map information of the facility W is information including position information on obstacles (posts or the like) that are placed in the facility W or on passages through which the moving body 10 can travel. It can be said that the map information is information indicating regions where the moving body 10 is movable in the region AR. In addition, the first route R1 and the second route R2 may be set also based on information on vehicle specifications of the moving body 10 in addition to the map information of the facility W. The information on vehicle specifications is, for example, on specifications that affect a route along which the moving body 10 is movable, such as a size or a minimum turning radius of the moving body 10. In a case where the first route R1 and the second route R2 are set based on the information of vehicle specifications, the first route R1 and the second route R2 may be set for each moving body.

The route acquisition unit 44 may set the first route R1 and the second route R2 without reading the first route R1 and the second route R2 set in advance. In this case, the route acquisition unit 44 may generate a route from the current position of the moving body 10 toward the placement region AR1 as the first route R1 based on the position information of the moving body 10 that is the target, the position information of the placement region AR1, and the map information of the facility W. Similarly, the route acquisition unit 44 may generate a route from the placement region AR1 toward the transport region AR2 as the second route R2 based on the position information of the placement region AR1, the position information of the transport region AR2, and the map information of the facility W.

### (Control Device of Moving Body)

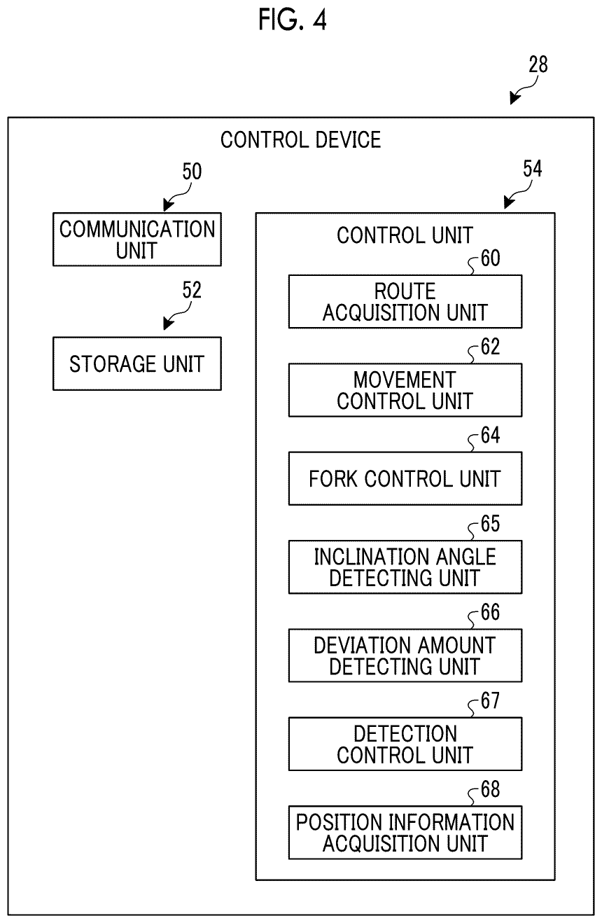

Next, the control device 28 of the moving body 10 will be described. FIG. 4 is a schematic block diagram of the control device of the moving body. The control device 28 is a device that controls the moving body 10. The control device 28 is a computer and as shown in FIG. 4, includes a communication unit 50, a storage unit 52, and a control unit 54. The communication unit 50 is a module used by the control unit 54 for communicating with an external device such as the information processing device 12 and may include, for example, an antenna or the like. A communication method of the communication unit 50 is wireless communication in the present embodiment, but the communication method may be any method. The storage unit 52 is a memory that stores various types of information, such as calculation contents of the control unit 54 and programs, and includes, for example, at least one of a main storage device, such as a RAM and a ROM, and an external storage device, such as an HDD.

The control unit 54 is a calculation device and includes, for example, a calculation circuit such as a CPU. The control unit 54 includes a route acquisition unit 60, a movement control unit 62, a fork control unit 64, an inclination angle detecting unit 65, a deviation amount detecting unit 66, a detection control unit 67, and a position information acquisition unit 68. The control unit 54 reads a program (software) from the storage unit 52 and executes the program to realize the route acquisition unit 60, the movement control unit 62, the fork control unit 64, the inclination angle detecting unit 65, the deviation amount detecting unit 66, the detection control unit 67, and the position information acquisition unit 68 and executes processing of the units. The control unit 54 may execute the processing with one CPU or may include a plurality of CPUs and execute the processing with the plurality of CPUs. In addition, at least part of the route acquisition unit 60, the movement control unit 62, the fork control unit 64, the inclination angle detecting unit 65, the deviation amount detecting unit 66, the detection control unit 67, and the position information acquisition unit 68 may be realized by a hardware circuit. In addition, a program for the control unit 54 stored in the storage unit 52 may be stored in a recording medium that can be read by the control device 28.

### (Route Acquisition Unit)

The route acquisition unit 60 acquires information on a route along which the moving body 10 moves (that is, information on the first route R1 and the second route R2). When the moving body 10 is selected as a work target, the route acquisition unit 60 may acquire information on the first route R1 and the second route R2 from the information processing device 12 or may read the information on the first route R1 and the second route R2 stored in the storage unit 52 in advance. In addition, the route acquisition unit 60 is not limited to acquiring the first route R1 and the second route R2 from the information processing device 12 and may set the first route R1 and the second route R2, for example, based on the posture of the target object P (inclination angles or deviation amounts of the claws 24A and 24B with respect to the target object P) when the target object P is picked up.

### (Movement Control Unit)

The movement control unit 62 controls a movement mechanism of the moving body 10, such as a drive unit or steering, to control the movement of the moving body 10. The movement control unit 62 moves the moving body 10 in accordance with the first route R1 and the second route R2 acquired or set by the route acquisition unit 60. The movement control unit 62 sequentially ascertains the position information of the moving body 10 to move the moving body 10 such that the moving body 10 passes through the first route R1 and the second route R2. An acquisition method of the position information of the moving body 10 is any method, but, for example, in the present embodiment, a detection body (not shown) is provided in the facility W, and the movement control unit 62 acquires information on the position and posture of the moving body 10 based on detection of the detection body. Specifically, the moving body 10 emits laser light toward the detection body and receives reflected light of the laser light from the detection body to detect the position and posture of the moving body 10 in the facility W. However, an acquisition method of information on the position and posture of the moving body 10 is not limited to using the detection body, and, for example, simultaneous localization and mapping (SLAM) may be used.

### (Fork Control Unit)

The fork control unit 64 controls an operation of the fork 24 of the moving body 10. Processing of the fork control unit 64 will be described later.

### (Inclination Angle Detecting Unit)

The inclination angle detecting unit 65 detects the inclination angles of the claws 24A and 24B with respect to the target object P in a case where the claws 24A and 24B of the fork 24 are inserted into the holes Pb of the target object P, respectively. The inclination angle refers to an angle formed by a line connecting the base end portions 24A1 and 24B1 (base end side sensors 23A and 23B) of the claws 24A and 24B with respect to the front surface Pa of the target object P. Processing of the inclination angle detecting unit 65 will be described later.

### (Deviation Amount Detecting Unit)

The deviation amount detecting unit 66 detects the deviation amounts of the claws 24A and 24B in the holes Pb in a case where the claws 24A and 24B of the fork 24 are inserted into the holes Pb of the target object P, respectively. The deviation amount refers to a distance by which a portion (for example, tip portions 24A2 and 24B2) of each of the claws 24A and 24B is displaced in the horizontal direction (right-left direction) from the reference position. Processing of the deviation amount detecting unit 66 will be described later.

### (Detection Control Unit)

The detection control unit 67 detects the position (relative position) of the target object P with respect to the moving body 10. Processing of the detection control unit 67 will be described later.

### (Position Information Acquisition Unit)

The position information acquisition unit 68 acquires the position information of the target object P based on a detection result of a position of the target object P from the detection control unit 67. The position information of the target object P is information indicating the position of the target object P with respect to the moving body 10 in a state where the fork 24 provided in the moving body 10 is inserted into the hole Pb formed in the target object P. Processing of the position information acquisition unit 68 will be described later.

### (Processing of Control Device)

Next, processing of the control device 28 when the moving body 10 loads the target object P in the placement region AR1 and unloads the target object P in the transport region AR2 will be described.

### (Movement Along First Route)

As shown in FIG. 1, the movement control unit 62 moves the moving body 10 to the target position A1 in accordance with the first route R1 acquired by the route acquisition unit 60. The first route R1 is a route set in advance from the map information or the like. When the moving body 10 reaches the target position A1, the fork control unit 64 moves the fork 24 to insert the fork 24 (the claws 24A and 24B) into the hole Pb to pick up the target object P.

(Control when Picking Up Target Object)

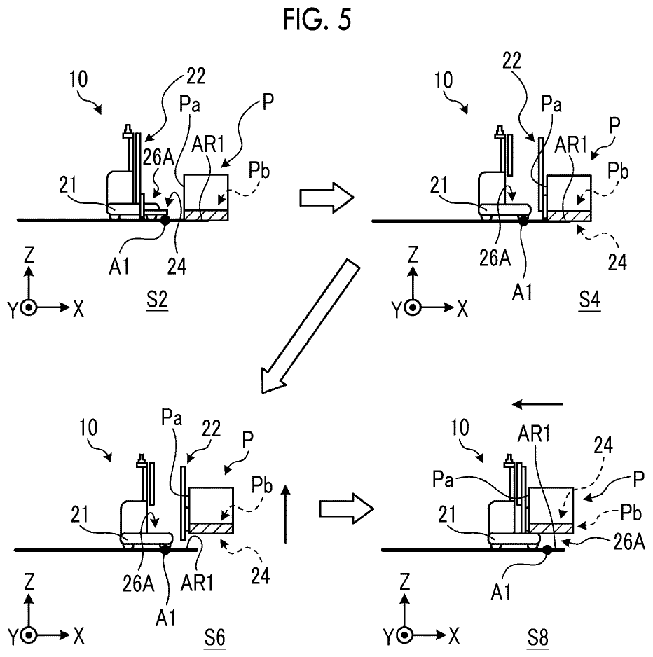

FIG. 5 is a schematic view showing an example of an operation of the moving body when picking up the target object. Hereinafter, an example in which the moving body 10 is positioned on a side opposite to the X-direction of the target object P (placement region AR1) and picks up the target object P positioned on a front direction side (first direction side), that is, herein, on the X-direction side, will be described. As shown in FIG. 5, when the moving body 10 reaches the target position A1 (step S2), the fork control unit 64 moves the fork 24 to the X-direction side (first direction side) and inserts the fork 24 into the hole Pb of the target object P (step S4). In the present embodiment, since the mast 22 and the fork 24 move integrally in the front-rear direction, the mast 22 and the fork 24 are moved to the X-direction side to insert the fork 24 into the hole Pb of the target object P. The fork control unit 64 may move the fork 24 in at least one of the up-down direction (the Z-direction or a side opposite to the Z-direction in the present example) and the horizontal direction (the Y-direction or a side opposite to the Y-direction in the present example) to align the position of the fork 24 with the position of the hole Pb. In this case, for example, the fork control unit 64 may move the fork 24 such that the position of the hole Pb and the position of the fork 24 are aligned with each other through feedback control after sequentially detecting the position of the hole Pb with a sensor such as a camera.

When the fork 24 is inserted into the hole Pb, the fork 24 is moved to a Z-direction side to move the target object P to an upward side, so that a bottom surface of the target object P is separated from the placement region AR1 and the target object P is held by the fork 24 (step S6). After that, the fork 24 is moved to the side opposite to the X-direction to return the position of the fork 24 to the original position (step S8). Accordingly, the pickup of the target object P is completed.

The fork control unit 64 picks up the target object P as described above. However, a control method of the fork 24 for picking up the target object P is not limited to the above description and may be any method.

### (Detection of Inclination Angle and Deviation Amount of Claw)

In the present embodiment, as described above, in step S4, the claws 24A and 24B of the fork 24 are inserted into the hole Pb of the target object P. In this case, in order to stably pick up the target object P and accurately drop the target object P in the transport region AR2, it is desirable to accurately detect the inclination angles and deviation amounts of the claws 24A and 24B with respect to the target object P when the claws 24A and 24B are inserted into the holes Pb of the target object P.

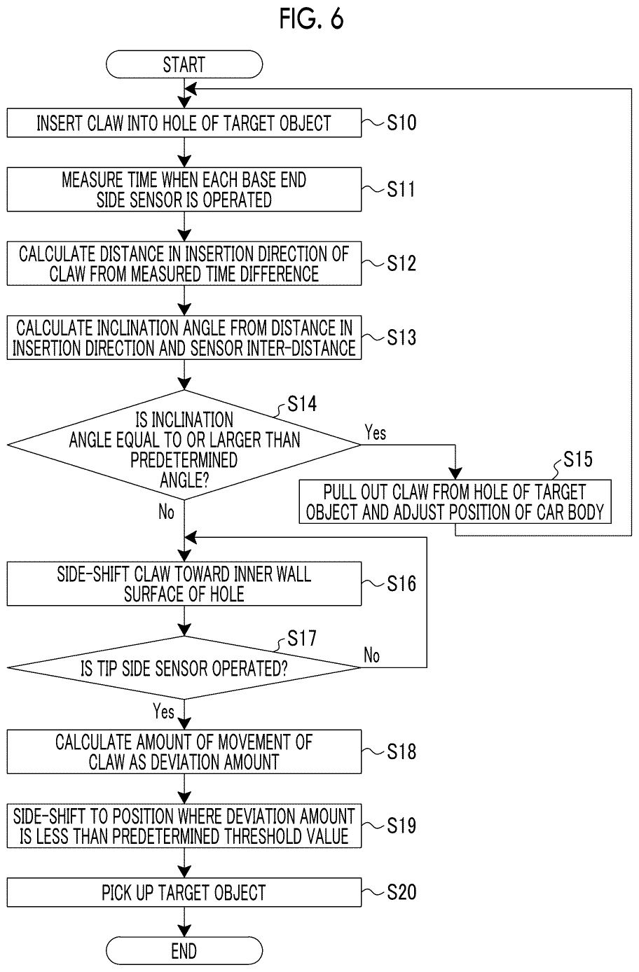

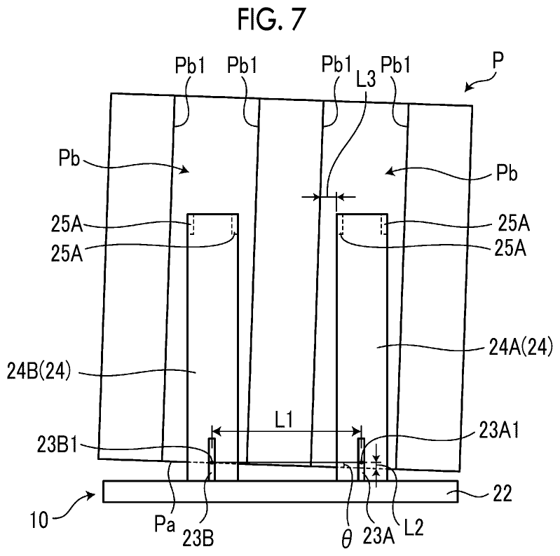

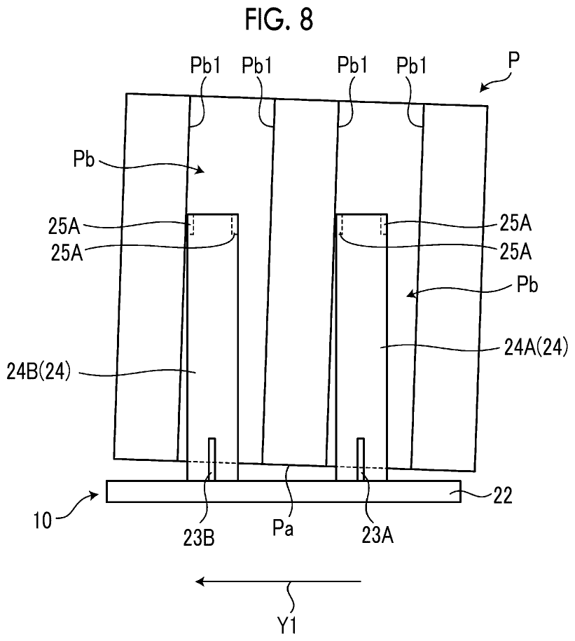

FIG. 6 is a flowchart showing a control procedure of detecting the inclination angle and deviation amount of the claw. FIGS. 7 and 8 are schematic views showing a positional relationship between the target object and the claw in the control procedure. As shown in FIG. 6, the fork control unit 64 moves the fork 24 to insert the claws 24A and 24B into the holes Pb of the target object P (step S10). At this time, the fork control unit 64 outputs the moving speeds of the claws 24A and 24B (fork 24) at the time of insertion to the inclination angle detecting unit 65.

The inclination angle detecting unit 65 measures a time when the base end side sensors 23A and 23B provided on the claws 24A and 24B are operated (step S11). As described above, the base end side sensors 23A and 23B are provided at the base end portions 24A1 and 24B1 of the claws 24A and 24B, respectively. In a case where the claws 24A and 24B are inserted into the holes Pb of the target object P, the base end side sensors 23A and 23B are operated by coming into contact with the front surface Pa of the target object P. Herein, in a case where the claws 24A and 24B are straightly inserted into the holes Pb of the target object P (that is, the inclination angle is 0), the base end side sensors 23A and 23B are operated simultaneously by coming into contact with the front surface Pa of the target object P. For this reason, there is no difference in time when the base end side sensors 23A and 23B are operated. On the other hand, in a case where the claws 24A and 24B are inclined and inserted into the holes Pb of the target object P, as shown in FIG. 7, a timing when operating points of the base end side sensors 23A and 23B come into contact with the front surface Pa of the target object P is different. Therefore, each time of the contact is measured.

Next, the inclination angle detecting unit 65 calculates a distance in an insertion direction of the claws 24A and 24B from the time difference at the measured time (step S12). Herein, the insertion direction of the claws 24A and 24B refers to a direction along the extending direction (longitudinal direction) of the claws 24A and 24B. The inclination angle detecting unit 65 calculates a distance L2 in the insertion direction of the claws 24A and 24B from a time difference between times when the operating points 23A1 and 23B1 of the base end side sensors 23A and 23B are operated by coming into contact with the front surface Pa of the target object P and the moving speeds of the claws 24A and 24B at the time of insertion.

Next, the inclination angle detecting unit 65 calculates an inclination angle θ from the calculated distance L2 in the insertion direction and a sensor inter-distance L1 between the base end side sensors 23A and 23B (step S13). The sensor inter-distance L1 is a value defined in advance, and the inclination angle detecting unit 65 reads and acquires information stored in the storage unit 52, for example. As shown in FIG. 7, in a case of the inclination angle θ, the sensor inter-distance L1 corresponds to an adjacent side, and the distance L2 in the insertion direction corresponds to an opposite side. For this reason, the inclination angle θ can be calculated by the following equation using the sensor inter-distance L1 and the distance L2 in the insertion direction.

θ=tan⁻¹(L2/L1)

Next, the inclination angle detecting unit 65 determines whether or not the calculated inclination angle θ is equal to or larger than a predetermined angle (step S14). The predetermined angle refers to an angle at which there is a high probability of a problem occurring in a case where the target object P is transported and unloaded (dropped) as it is, and is defined for each size or type of the target object, for example.

In this determination, in a case where the inclination angle θ is equal to or larger than the predetermined angle (step S14; Yes), the movement control unit 62 and the fork control unit 64 pull out the claws 24A and 24B from the holes Pb of the target object P and adjust the position of the car body 20 with respect to the target object P (step S15). That is, when the claws 24A and 24B are reinserted into the holes Pb of the target object P, the position of the car body 20 is adjusted such that the inclination angles θ of the claws 24A and 24B are less than the predetermined angle. After that, the processing returns to step S10, and steps S10 to S14 are executed again. Insofar as the inclination angles θ of the claws 24A and 24B can be corrected, for example, the position of the car body 20 may be adjusted in a state where the claws 24A and 24B are inserted into the holes Pb of the target object P.

On the other hand, in a case where the inclination angle θ is not equal to or larger than the predetermined angle (step S14; No), the fork control unit 64 side-shifts the claws 24A and 24B (fork 24) toward inner wall surfaces (inner walls) Pb1 of the hole Pb in a state where the claws 24A and 24B are inserted into the holes Pb (step S16). Specifically, as shown in FIG. 8, the fork control unit 64 side-shifts (moves in the horizontal direction) to a side where the claws 24A and 24B are inclined (in the example of FIG. 8, in an arrow Y1 direction). In this case, since the claws 24A and 24B inserted into the holes Pb do not hold the target object P, even if the claws 24A and 24B are side-shifted toward the inner wall surfaces Pb1 of the holes Pb, the target object P does not follow the movement of the claws 24A and 24B, and the claws 24A and 24B move in the horizontal direction inside the holes Pb.

Next, the deviation amount detecting unit 66 determines whether or not the tip side sensors 25A and 25B are operated (step S17). As described above, the tip side sensors 25A and 25B are provided at the tip portions 24A2 and 24B2 of the claws 24A and 24B, respectively. For this reason, as any one of the tip side sensors 25A and 25B is operated, it can be detected that the tip portions 24A2 and 24B2 of the claws 24A and 24B are in contact with the inner wall surfaces Pb1 of the holes Pb. In this case, the deviation amount detecting unit 66 acquires the amount of movement of the claws 24A and 24B (fork 24) in the horizontal direction from the fork control unit 64. In this determination, in a case where the tip side sensors 25A and 25B are not operated (step S17; No), the processing returns to step S16.

In addition, in a case where the tip side sensors 25A and 25B are operated (step S17; Yes), the deviation amount detecting unit 66 calculates the acquired amount of movement as a deviation amount (step S18). For example, in the examples of FIGS. 7 and 8, the deviation amounts of the claws 24A and 24B are a length L3.

Next, the fork control unit 64 side-shifts the claws 24A and 24B (fork 24) in an opposite direction to a position where the deviation amount is less than a predetermined threshold value (step S19). Accordingly, the positions of the claws 24A and 24B with respect to the target object P are corrected. The deviation amount detecting unit 66 compares the calculated deviation amount with the predetermined threshold value and calculates a distance to a position where the deviation amount is less than the threshold value. The threshold value is a value defined according to the size of the target object and the width of the hole Pb in the horizontal direction (Y-direction). For example, in a case where the calculated deviation amount is 15 mm and the threshold value is 10 mm, the distance to the position where the deviation amount is less than the threshold value is 5 mm or more. The fork control unit 64 acquires the calculated distance and side-shifts the claws 24A and 24B (fork 24) in the opposite direction to the position where the deviation amount is less than the predetermined threshold value. When the calculated deviation amount is less than the predetermined threshold value, a state (a state where the tip portions 24A2 and 24B2 of the claws 24A and 24B are in contact with the inner wall surfaces Pb1 of the holes Pb) may be maintained as it is.

Next, the fork control unit 64 raises the claws 24A and 24B (fork 24) in a height direction (Z-direction) to pick up the target object P (step S20), and ends the processing.

### (Detection of Position of Target Object P)

The detection control unit 67 detects the position of the target object P with respect to the moving body 10, and the position information acquisition unit 68 acquires the position information of the target object P indicating the position of the target object with respect to the moving body 10 in a state where the fork 24 is inserted into the hole Pb, based on a detection result of the position of the target object P from the detection control unit 67. The state where the fork 24 is inserted into the hole Pb means that the entire fork 24 from the tip to a base end is positioned in the hole Pb. Hereinafter, this processing will be specifically described.

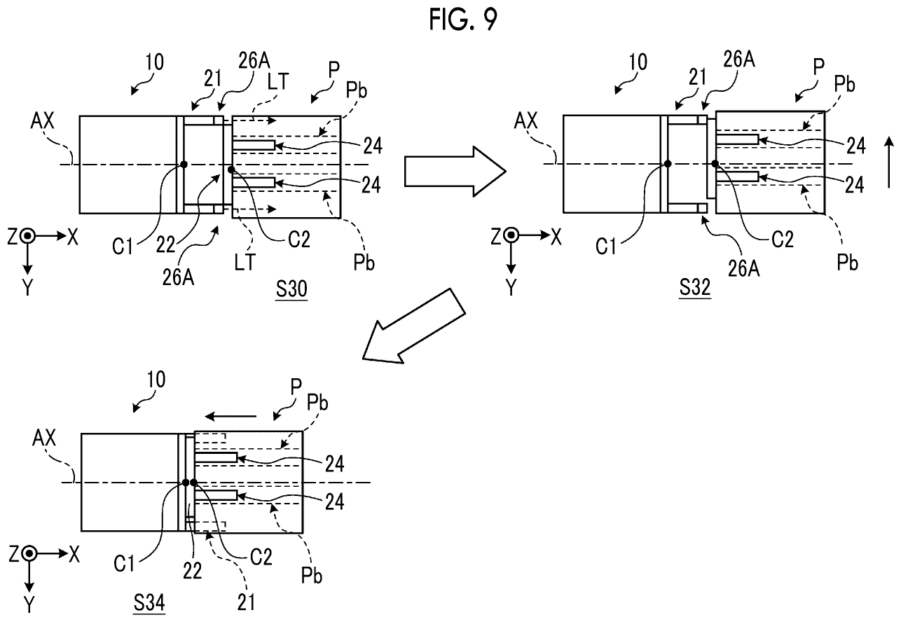

FIG. 9 is a schematic view showing processing of acquiring position information of the target object. The detection control unit 67 detects the position (relative position) of the target object P with respect to the moving body 10, that is, the position of the target object P in the coordinate system of the moving body 10. The detection control unit 67 detects the position of the target object P with respect to the moving body 10 in the horizontal direction (second direction) intersecting the front direction (first direction). The detection control unit 67 detects the position of the target object P with respect to the moving body 10 in the Y-direction by causing the sensor 26A to detect the target object P. In the present embodiment, as shown in step S20 of FIG. 9, the detection control unit 67 causes the sensor 26A to detect the position of the target object P in a state where the fork 24 of the moving body 10 is inserted into the hole Pb. That is, it is preferable that the detection control unit 67 causes the sensor 26A to detect the position of the target object P in a state where the target object P is picked up by the fork 24 and the target object P is positioned on a front side of the sensor 26A (state of step S6 in the example of FIG. 5). That is, in the present embodiment, since the sensor 26A is provided at the tip of the straddle leg 21, the position of the target object P can be detected before the fork 24 (target object P) is returned to the side opposite to the X-direction.

For example, in a case where the sensor 26A is configured to emit laser light LT, the detection control unit 67 causes the sensor 26A to emit the laser light LT to the target object P. The target object P reflects the emitted laser light LT as reflected light, and the sensor 26A detects (receives) the reflected light from the target object P. The detection control unit 67 detects the position of the target object P with respect to the moving body 10 based on the detection result of the reflected light from the sensor 26A.

A detection method of the position of the target object P in the Y-direction in the detection control unit 67 is not limited to the above description. For example, the detection control unit 67 may detect the position and posture of the target object P by emitting the laser light LT while performing scanning in the horizontal direction.

As described above, the detection control unit 67 detects the position of the target object P in the Y-direction in a state where the target object P is picked up by the fork 24. For this reason, the position information acquisition unit 68 acquires the detection result of the position of the target object P in the Y-direction as the position information of the target object P. In this case, the position information of the target object P includes the inclination angle and deviation amount of the fork 24 (claws 24A and 24B) with respect to the target object P described above.

### (Position Adjustment of Target Object P)

In the present embodiment, the fork control unit 64 moves the fork 24 in the horizontal direction (the Y-direction or the side opposite to the Y-direction) in a state where the fork 24 is inserted into the hole Pb, based on the position information of the target object P (the position of the target object P in the Y-direction), thereby moving the target object P in the horizontal direction. Accordingly, the fork control unit 64 adjusts the position of the target object P with respect to the moving body 10 in the horizontal direction. In the example of FIG. 9, it is shown that the target object P is moved to the side opposite to the Y-direction by moving the fork 24 to the side opposite to the Y-direction (step S32). In the present embodiment, for example, it is preferable that the fork control unit 64 moves the target object P such that a distance in the horizontal direction between a center position C1 of the moving body 10 in the horizontal direction and a center position C2 of the target object P in the horizontal direction is equal to or less than a predetermined value. Accordingly, the distance between the center position C2 of the target object P mounted on the stopped fork 24 and the center position C1 of the moving body 10 is equal to or less than the predetermined value, and in other words, it is possible to position the center positions C1 and C2 substantially on the same axis (on an axis AX) in the X-direction. Therefore, by controlling in this manner, the center position C2 of the target object P can be appropriately aligned with the center position C1 of the moving body 10.

Finally, the moving body 10 returns the fork 24 to the side opposite to the X-direction (step S34) and completes the position adjustment of the target object P in the horizontal direction.

### (Movement Along Second Route)

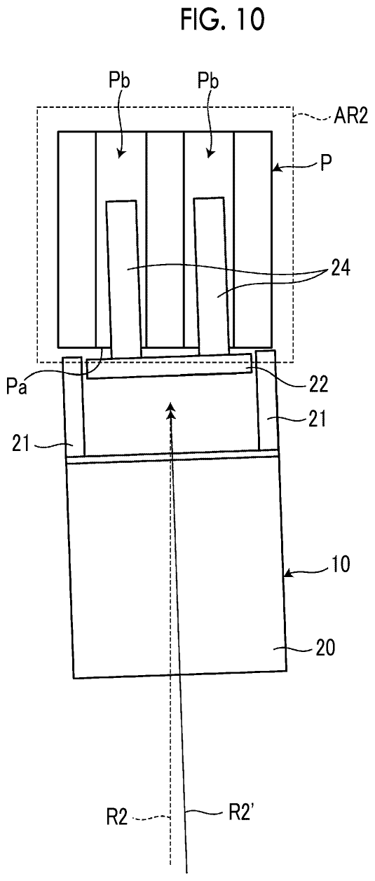

FIG. 10 is a schematic view showing processing of moving the moving body holding the target object to the transport region. When the moving body 10 picks up the target object P and completes the position adjustment of the target object P in the horizontal direction, the movement control unit 62 moves the moving body 10 to the transport region AR2 in accordance with the second route R2 acquired by the route acquisition unit 60. In the present embodiment, since the inclination angles θ and deviation amounts of the claws 24A and 24B are detected, the route acquisition unit 60 sets (updates) a second route R2′ corrected based on the inclination angles θ and deviation amounts of the claws 24A and 24B.

That is, the route acquisition unit 60 corrects the second route R2′ newly set for unloading the target object P in a correct posture without an inclination with respect to the transport region AR2, based on the inclination angles θ and deviation amounts of the claws 24A and 24B. In this case, for example, the route acquisition unit 60 may set a route inclined by the inclination angle θ with respect to the second route R2 set in advance as a new second route R2′. In addition, the position of the target position A2 (see FIG. 1) may be corrected based on the position obtained by deviating the position of the target position A2 by the deviation amounts of the claws 24A and 24B, and a route to the corrected target position A2 may be set as the new second route R2′. The movement control unit 62 moves the moving body 10 along the corrected second route R2′. An entity that calculates the corrected second route R2′ is not limited to the route acquisition unit 60 of the moving body 10, and, for example, the route acquisition unit 44 of the information processing device 12 may calculate the corrected second route R2′.

When the moving body 10 travels along the corrected second route R2′ and reaches the target position A2, the fork control unit 64 moves the fork 24 to drop the target object P held by the fork 24 (claws 24A and 24B) in the correct posture into the transport region AR2. In the step of dropping the target object P, the step of picking up the target object P shown in FIG. 5 may be performed in reverse order.

Since a control method of a moving body according to the present embodiment includes a step of inserting the claws 24A and 24B into the holes Pb formed in the target object P, a step of detecting the inclination angles θ of the claws 24A and 24B inserted into the holes Pb with respect to the target object P, and a step of detecting the deviation amounts of the claws 24A and 24B inserted into the holes Pb, the deviation amounts of the claws 24A and 24B when the claws 24A and 24B are inserted into the holes Pb of the target object P can be accurately detected, and the target object P can be appropriately transported.

In the control method of a moving body according to the present embodiment, the step of detecting the inclination angle θ is calculating the inclination angle based on a time difference between times when the base end side sensors 23A and 23B provided at the respective base end portions 24A1 and 24B1 of the claws 24A and 24B and the front surface Pa of the target object P come into contact with each other and on a moving speed when the claws 24A and 24B are inserted into the holes Pb. Therefore, the inclination angle can be easily and accurately calculated.

In the control method of a moving body according to the present embodiment, in the step of detecting the deviation amounts of the claws 24A and 24B, the deviation amounts of the claws 24A and 24B are calculated based on a movement distance until the claws 24A and 24B are side-shifted in a direction intersecting the extending direction of the claws 24A and 24B in a state where the claws 24A and 24B are inserted into the holes Pb of the target object P, and one of the tip side sensors 25A and 25B provided at the tip portions 24A2 and 24B2 of the claws 24A and 24B comes into contact with the inner wall surface Pb1 of the hole Pb. Therefore, the deviation amounts can be easily and accurately calculated.

The control method of a moving body according to the present embodiment includes a step of moving the claws 24A and 24B in the direction intersecting the extending direction of the claws 24A and 24B based on detected deviation amounts in a state where the claws 24A and 24B are inserted into the holes Pb of the target object P and correcting the positions of the claws 24A and 24B with respect to the target object P. Therefore, the claws 24A and 24B can be corrected to have appropriate positions.

In the control method of a moving body according to the present embodiment, in the step of correcting the positions of the claws 24A and 24B, the claws are moved to the positions where the deviation amounts are less than the predetermined threshold value. Therefore, the claws 24A and 24B can be easily corrected to have appropriate positions.

Since the control method of a moving body according to the present embodiment includes a step of acquiring the second route (route) R2′ toward the transport region AR2, which is newly set for unloading the target object P, based on the detected inclination angle and the detected deviation amount, a step of moving the moving body 10 along the second route R2′, and a step of unloading the target object P in the transport region AR2, the target object P held in an inclined state or a position deviation state with respect to the moving body 10 can be unloaded in the transport region AR2 in a correct posture.

### Second Embodiment

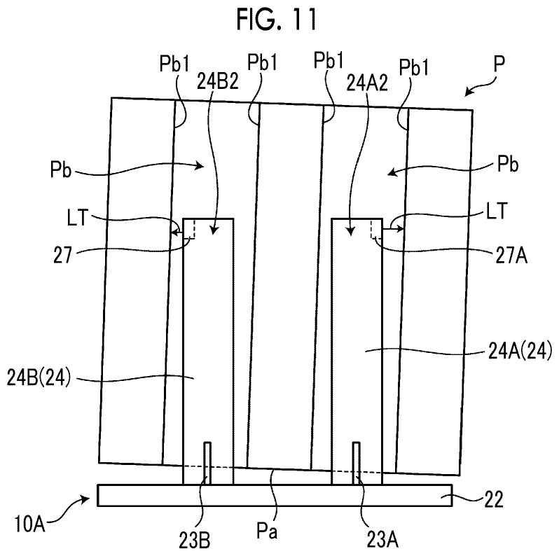

Next, a second embodiment will be described. FIG. 11 is a schematic view for describing an operation of detecting a deviation amount of a claw in a moving body according to a second embodiment. The second embodiment is different from the first embodiment in that a moving body 10A includes tip side sensors 27A and 27B formed of light sensors on outer surfaces (corner portions) of the tip portions 24A2 and 24B2 of the claws 24A and 24B. In the second embodiment, the same reference signs are assigned to parts having the same configurations as those in the first embodiment, and description thereof will be omitted.

As described above, the light sensors can be used as the tip side sensors 27A and 27B. The tip side sensors 27A and 27B are so-called one-dimensional (1D)-LiDAR and emit the laser light (light) LT to the inner wall surface Pb1 of the hole Pb to detect a separation distance between the inner wall surface Pb1 and the tip side sensors 27A and 27B (the tip portions 24A2 and 24B2 of the claws 24A and 24B) from reflected light of the emitted laser light LT. In the present embodiment, the detected separation distance is the deviation amount of the claws 24A and 24B.

In the step of detecting the deviation amounts of the claws 24A and 24B in the control method of a moving body according to the present embodiment, in a state where the claws 24A and 24B are inserted into the holes Pb of the target object P, light is emitted to the inner wall surface Pb1 of the hole Pb from the tip side sensors 27A and 27B provided on the claws 24A and 24B, and the deviation amounts of the claws 24A and 24B are calculated based on a separation distance acquired by receiving reflected light from the inner wall surface Pb1. With this configuration, unlike in the first embodiment, it is not necessary to side-shift the claws 24A and 24B in the holes Pb in order to detect the deviation amounts, and improvement in work efficiency (throughput) can be expected.

In the present embodiment, the tip side sensors 27A and 27B are provided on the outer surfaces (corner portions) of the tip portions 24A2 and 24B2 of the respective claws 24A and 24B, but may be provided on both side surfaces.

### Third Embodiment

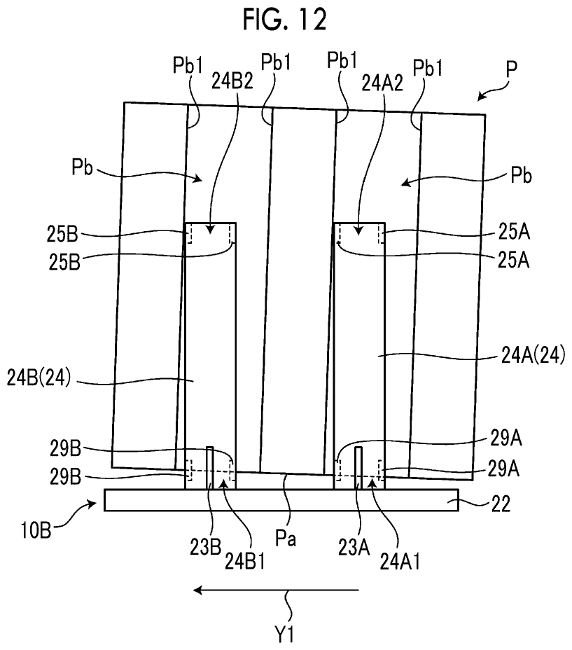

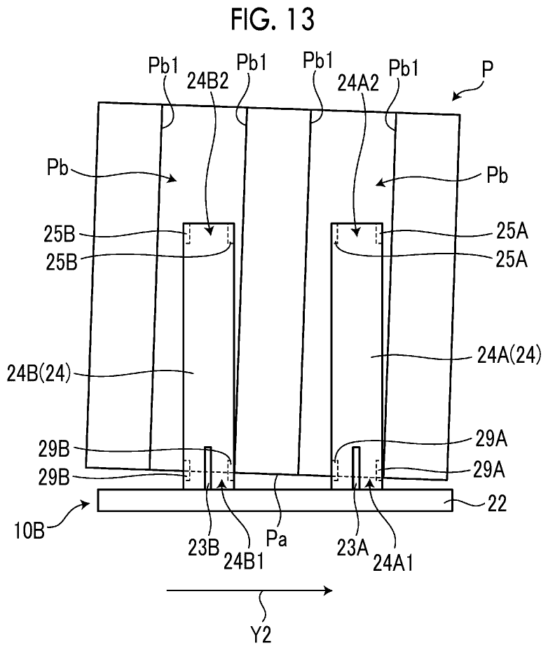

Next, a third embodiment will be described. FIGS. 12 and 13 are schematic views for describing an operation of detecting a deviation amount of a claw in a moving body according to a third embodiment. The third embodiment is different from the first embodiment in that a moving body 10B includes base end side contact sensors 29A and 29B on both side surfaces of the base end portions 24A1 and 24B1 of the claws 24A and 24B. In the third embodiment, the same reference signs are assigned to parts having the same configurations as those in the first embodiment, and description thereof will be omitted.

The base end side contact sensors 29A and 29B can use pressure sensors as in the case of the tip side sensors 25A and 25B. For example, as shown in FIG. 12, in a case where the tip portions 24A2 and 24B2 of the claws 24A and 24B come into contact with the inner wall surface Pb1 of the hole Pb and at least one of the tip side sensors 25A and 25B is operated when the claws 24A and 24B are inserted into the holes Pb of the target object P, the deviation amounts of the claws 24A and 24B cannot be detected with the method of the first embodiment.

For this reason, in the present embodiment, a movement distance until the claws 24A and 24B are moved (side-shifted) in the horizontal direction to the side opposite to a contacted side (a Y2-direction in FIG. 13), the base end portions 24A1 and 24B1 of the claws 24A and 24B come into contact with the inner wall surface Pb1 of the hole Pb, and one of the base end side contact sensors 29A and 29B is operated is calculated as a deviation amount.

In the control method of a moving body according to the present embodiment, in a case where at least one of the tip side sensors 25A and 25B of the claws 24A and 24B is operated in a state where the claws 24A and 24B are inserted into the holes Pb of the target object P, the step of detecting the deviation amounts of the claws 24A and 24B is calculating, as a deviation amount, a movement distance until the claws 24A and 24B are moved in the horizontal direction to the side opposite to the contacted side, the base end portions 24A1 and 24B1 of the claws 24A and 24B come into contact with the inner wall surface Pb1 of the hole Pb, and one of the base end side contact sensors 29A and 29B is operated. With this configuration, for example, even in a case where the tip portions of the claws 24A and 24B come into contact with the inner wall surface Pb1 of the hole Pb, the deviation amounts of the claws 24A and 24B can be accurately and easily detected.

Although the embodiments of the present disclosure have been described above, the embodiments are not limited by the content of the embodiments. In addition, the components described above include those that can be easily assumed by those skilled in the art, those that are substantially the same, and those that are within a so-called equivalent range. Further, the components described above can be combined as appropriate. Further, various omissions, replacements, or modifications of the components can be made without departing from the concept of the embodiments described above.

### REFERENCE SIGNS LIST

1 movement control system
10, 10A, 10B moving body
23A, 23B base end side sensor
24 fork
24A, 24B claw
24A1, 24B1 base end portion
24A2, 24B2 tip portion
25A, 25B tip side sensor
27A, 27B tip side sensor
28 control device
29A, 29B base end side contact sensor
60 route acquisition unit
62 movement control unit
64 fork control unit
65 inclination angle detecting unit
66 deviation amount detecting unit
67 detection control unit
68 position information acquisition unit
AR2 transport region
P target object
Pa front surface
Pb hole
Pb1 inner wall surface (inner wall)
R1 first route
R2, R2′ second route (route)

1. A control method of a moving body that includes a pair of claws for holding a target object which is a transport target, the control method comprising:
a step of inserting the claws into an opening formed in the target object;
a step of detecting inclination angles of the claws inserted into the opening with respect to the target object; and
a step of detecting deviation amounts of the claws inserted into the opening, wherein
in the step of detecting the inclination angles, the inclination angles are calculated based on a time difference between times when respective base end portions of the claws and the target object come into contact with each other and on a speed at which the claws are inserted into the opening.

2. (canceled)

3. The control method of a moving body according to claim 1, wherein in the step of detecting the deviation amounts of the claws, the deviation amounts of the claws are calculated based on a movement distance until the claws are moved in a direction intersecting an extending direction of the claws in a state where the claws are inserted into the opening and a tip portion of one claw comes into contact with an inner wall of the opening.

4. The control method of a moving body according to claim 1, wherein in the step of detecting the deviation amounts of the claws, the deviation amounts of the claws are calculated based on a separation distance acquired by emitting light from light sensors provided on the claws to an inner wall of the opening in a state where the claws are inserted into the opening and receiving reflected light from the inner wall.

5. The control method of a moving body according to claim 1, further comprising a step of correcting positions of the claws with respect to the target object by moving the claws in a direction intersecting an extending direction of the claws in a state where the claws are inserted into the opening, based on the detected deviation amount.

6. The control method of a moving body according to claim 5, wherein in the step of correcting the positions of the claws, the claws are moved to positions where the deviation amounts are less than a predetermined threshold value.

7. The control method of a moving body according to claim 1, further comprising:
a step of acquiring a route toward a placement region where the target object is unloaded, which is set based on the detected inclination angles and the detected deviation amounts;
a step of moving the moving body along the route; and
a step of unloading the target object in the placement region.

8. A moving body that includes a pair of claws for holding a target object which is a transport target, the moving body comprising:
a fork control unit that inserts the claws into an opening formed in the target object;
an inclination angle detecting unit that detects inclination angles of the claws inserted into the opening with respect to the target object; and
a deviation amount detecting unit that detects deviation amounts of the claws inserted into the opening, wherein
the inclination angle detecting unit calculates the inclination angles based on a time difference between times when respective base end portions of the claws and the target object come into contact with each other and on a speed at which the claws are inserted into the opening.

9. A non-transitory computer-readable recording medium having stored thereon a program causing a computer to execute a control method of a moving body that includes a pair of claws for holding a target object which is a transport target, the program causing the computer to execute:
a step of inserting the claws into an opening formed in the target object;
a step of detecting inclination angles of the claws inserted into the opening with respect to the target object; and
a step of detecting deviation amounts of the claws inserted into the opening, wherein
in the step of detecting the inclination angles, the inclination angles are calculated based on a time difference between times when respective base end portions of the claws and the target object come into contact with each other and on a speed at which the claws are inserted into the opening.
